(19) United States
(12) Patent Application Publication
(10) Pub. No.: US 2004/0088220 A1
(43) Pub. Date: May 6, 2004

(54) Systems and methods for providing rotatable advertising and sponsorship in public areas and providing for the education and entertainment of children

(76) Inventors: J. Brad Knight, Park City, UT (US); Michael Perog, Park City, UT (US)

Correspondence Address: Michael F. Krieger, Kirton & McConkie, P.O. Box 45120, Salt Lake, UT, 84111, US

(21) Appl. No.: 10/349,000

(22) Filed: Jan. 22, 2003

Related U.S. Application Data
(63) Continuation-in-part of application No. 10/286,488, filed on Nov. 1, 2002.

(51) Int. Cl. G06F 17/60

(52) U.S. Cl. 705/14

(57) ABSTRACT

Systems and methods for providing advertising in a public educational system configured for children. Revenue is generated by selling advertising space within the system. The advertising space takes the form of, but is not limited to enclosed display cases, experimental play areas, two-sided screen televisions and banners. Sponsorship supports the costs of the education zone equipment, location in shopping center, and maintenance of the location, as well as a remunerating and profiting investors and owners. Accordingly, the education zone provides a method for advertising by allowing businesses to sponsor different modular elements. The cost of sponsorship depends on the size and/or utility of the sponsored item. Toys displayed or used in the experimental zone can be purchased on site from vending machines, ordered on-line at computers located on site, or purchased from catalogs also offered in racks on site.

### RELATED APPLICATIONS

This application is a continuation-in-part of and claims priority to U.S. patent Ser. No. 10/286,488, filed Nov. 1, 2002, entitled METHODS FOR PROVIDING FAMILY EDUCATIONAL PLAY AND SOCIAL CENTERS WITH ROTATABLE ADVERTISING AND SPONSORSHIP.

### BACKGROUND

2. Field of the Invention

The present invention relates to systems and methods for advertising, such as backlit panels, retail sales from attached or associated kiosks within 10 feet of the play area and social centers or pushcarts within 10 feet of the play area and social centers, and sponsorship. In particular, the present invention relates to providing advertising and sales in public areas such as retail shopping malls, airports, movie theater entrances, discount and outlet malls, government buildings or covered outside locations in parking lots that also allow for the interaction and education of children and adults.

2. Background

Shopping malls may currently provide rest areas for shoppers and some malls provide play areas for children. These play areas are usually directed to children below the age of seven and consist of fixed play equipment, such as slides, desks, and plastic play sets. Malls also employ pushcarts and kiosks to offer diversity to vendors when selling their wares. Some malls also have isolated advertising panels associated with way-finding directories.

### SUMMARY AND OBJECTS OF THE INVENTION

The present invention provides advertising, retail sales, and sponsorship opportunities in a public area allowing children to play and learn. It is an object of some embodiments of the present invention to provide attached, associated, and integrated advertising, and retail sales from attached or associated kiosks and online shopping that are presented in an area where parents will see the advertising and shop at the retailing kiosks and online, while allowing their children to play in an associated play area.

It is another object of some embodiments of the present invention to provide a play area, which is divided into three zones, each zone designed to appeal to children in different age groups.

Additional objects and advantages of the invention will be set forth in the description that follows and in part will be obvious from the description or may be learned by the practice of the invention. The objects and advantages of the invention may be realized and obtained by means of the instruments and combination particularly pointed out in the appended claims.

To achieve the foregoing objects, and in accordance with the invention as described herein, advertising, retailing, sponsorships and play area are located together in a public location, such as a shopping center, mall, airport, or other venue. The present invention provides seating that surrounds the play area. By utilizing space in a public area, such as a shopping mall, government building, airport, covered parking or movie theater entrance, the present invention allows adults to consolidate personal and parental responsibilities by enabling parents to spend time playing with and educating their children while shopping at the attached retailing kiosks, computers, and other attached venues. In addition, the seating area allows adults to interact with each other while tending to their children. The adults are also presented with educational and entertainment opportunities.

### BRIEF DECRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 illustrates an embodiment of advertising, sponsorship and retail sales for children's entertainment and education in a shopping environment;

FIG. 2 illustrates an embodiment with two large screen TVs for the placement of advertising and the viewing of children, videotapes with entertainment or educational content;

FIG. 3 illustrates a zone designed for children eight to twelve providing computers, video games, sponsorships and educational displays;

FIG. 4 illustrates another embodiment of the system with kiosks as part of the theme of the play area either attached and/or with ten feet of the play area; and

FIG. 5 illustrates typical cash flows from the advertising, kiosk retailing and in multiple sponsorship venues made available inside and surrounding the play areas.

### DETAILED DESCRIPTION OF THE PREFERRED EMBODIMENTS

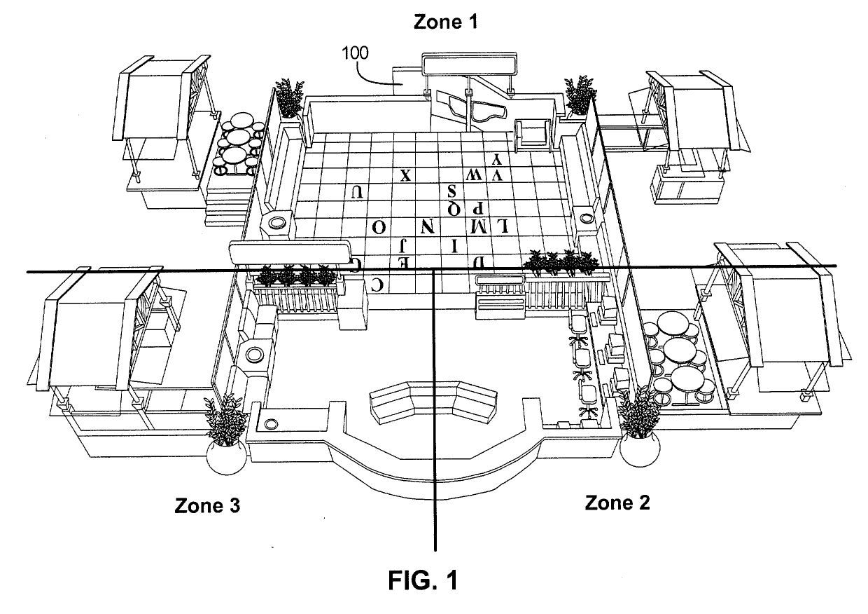

The present invention relates to systems and methods for providing an educational and social zone for children and adults to interact, as well as providing advertising and retail sales opportunities for one or more sponsors. FIG. 1 illustrates an embodiment of the present invention as used by a number of children and adults. The inside perimeter of the area is lined with seating, trash disposal areas and diaper changing areas. Also located inside the perimeter are large screen televisions, space for banners and flat advertisements. The perimeter is created with a transparent panel incorporated into large portions of the wall to allow parents to monitor the play of children.

For security purposes there is only one entrance 100. The advertising and education area is divided into three zones as shown in FIG. 1. Zone one may accommodate children ages 2 through 8 and their parents. Zone one has age-appropriate activities along with themes appropriate to that age group. For example, the carpeting in zone one may have an alphabet theme and the blocks and other toys provided may have themes that tie-in with advertisers selling products directed to that age group.

When viewed from the entrance, the section at the back left comer of the area is labeled zone 2 and is designed to cater to the needs of children age's eight to twelve.

Zone 2 has computer stations and video game stations and may include other displays such as museum quality education displays and other elements appropriate for children of this age group.

Zone 3 may be located to the back and the right and is designed for children from infants through two years of age. This area will have simple play objects such as blocks, and will provide a diaper-changing table. These three zones are separated by an open picket-type fence, which is also integrated into other elements of the area.

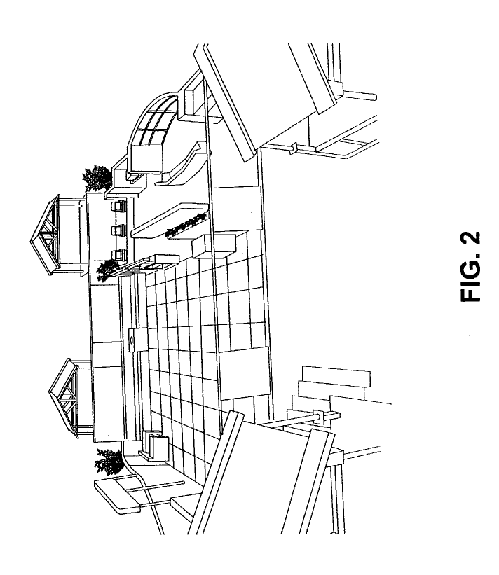

Located within the perimeter wall 102 are several large television screens 104 upon which videotapes providing entertainment or educational content will be shown along with sponsorship and advertising information. The perimeter 102 is also provided with a Plexiglas sound-dampening insert 106 to reduce the noise that is either produced in the play area or to reduce noise incursion from outside of the quieter parts of the play area. As can be seen in FIG. 2, these large screen televisions 104 are viewable on both sides so that passers-by will also see the sponsorship and advertising information and may be encouraged to enter the area.

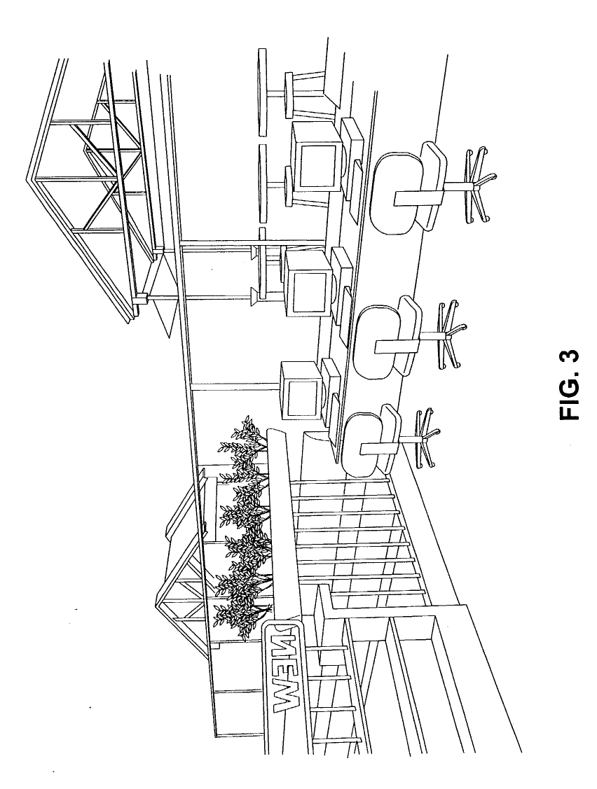

FIG. 3 shows zone 2 in more detail including the computer area 108 for adolescents. Located in an area 110 in between zone 1 and zone 2 or between zone 1 and zone 3 is an advertiser toy testing area, which allows advertisers, sponsors or mall tenants and or retail kiosks to display new toys and other products for a fee. It allows parents and their children to test the products to determine whether they wish to purchase those products. The products in those areas will be appropriate for the age specific zone in which they are located.

For example, toys located in zone 2 may be more sophisticated such as software or video games and will be at an educational level at which parents and children in that zone would be interested. Those toys demonstrated in zone 3 will be of a more simple nature and will be designed for toddlers.

Also located in zone 1 will be a Plexiglas display case 112 for family oriented products and items of interest. Spaces within this display case will be rented out to mall tenants or outside entities for advertising interest.

Referring now to FIGS. 1, 2 and 3, retail merchandising units (kiosks, pushcarts and other vending devices) 114 will be integrated into the outer perimeter. These kiosks or pushcarts are either attached directly to the perimeter wall or associated with the wall or placed in close proximity to the wall. As used herein the term “associated” means within ten feet of the perimeter wall. These kiosks or carts will be leased to companies with a target market and products appropriate and appealing to families with children falling within the age groups of the three zones and general demographics of mall shoppers. The lessees of this space will have the opportunity to tie into the products demonstrated or to the displays within the area and to charge fees for advertising. For example, in zone 1 and zone 2, book areas are provided in which books are stocked. One of the retail merchandise units could be leased by a bookstore offering to sell the books, which may be viewed in this area. Similarly, the toy testing areas may be stocked with toys that are offered by a company leasing one of the retail-merchandising unit (kiosks).

In addition to the retail-merchandising unit, there are also external seating areas located outside of the perimeter of the play area, in which additional retail merchandising unit's area placed and will have food service advertising. Thus adults can eat at the outer eating areas without bringing food into the play area. Because there is a transparent perimeter wall, these adults can observe their children as they eat. Food may be sold from one of the merchandising units to cater to these adults.

The present invention also provides educational opportunities. Children may access educational software and websites at the computer stations. In addition, adults have access to computer stations to take online tests to evaluate their current parenting skills in a variety of areas. In the evenings, parents can take parenting classes to improve their skills.

Sponsors and advertisers not only benefit from exposure through advertising, but parents visiting the system may access through the computers a list of sponsors and be linked directly to a sponsor's website to receive coupons and to purchase items. Sponsors and advertisers may demonstrate toys in the demonstration area and offer special pricing if purchased at the site through the web page.

The site of the system also provides a stage and sound system for public rental or for free, depending on the nature of the use. Public interest groups could then meet or put on presentations to shoppers or the relevant public.

Additional advertising is provided through permanent elevated, double-sided, backlit sign cabinets placed over the entrance and placed at a conspicuous location on the perimeter wall. These signs are approximately 40 inches by 50 inches and the backlit panels allow national advertisers to obtain large contracts because of the many malls in which they have signage. Custom programming may also be provided having a video content appropriate for advertising at these locations.

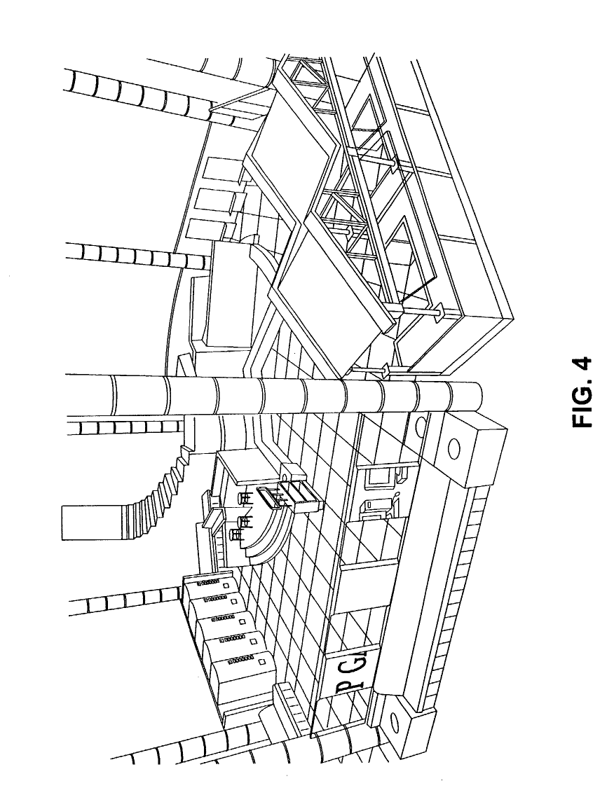

FIG. 4 illustrates other advertising features such as a coupon rack that mall tenants may pay to use to offer special discounts. Forty inch by 50 inch, double-sided backlit advertising panels are integrated into the play areas for national advertisers and sponsors. The sponsors and advertisers may be rotated periodically. A flat panel advertising television is directed toward the seating area for parents. It will show weather, sports, news and advertisements. Also shown in FIG. 4 are integrated vending machines dispensing snacks, taking pictures, providing kiddie rides, and selling video games and computer accessories. Parents also have access to a catalog display system either inside the play area or at seating areas around the perimeter space in this catalog display will be leased to mall tenants or national advertisers.

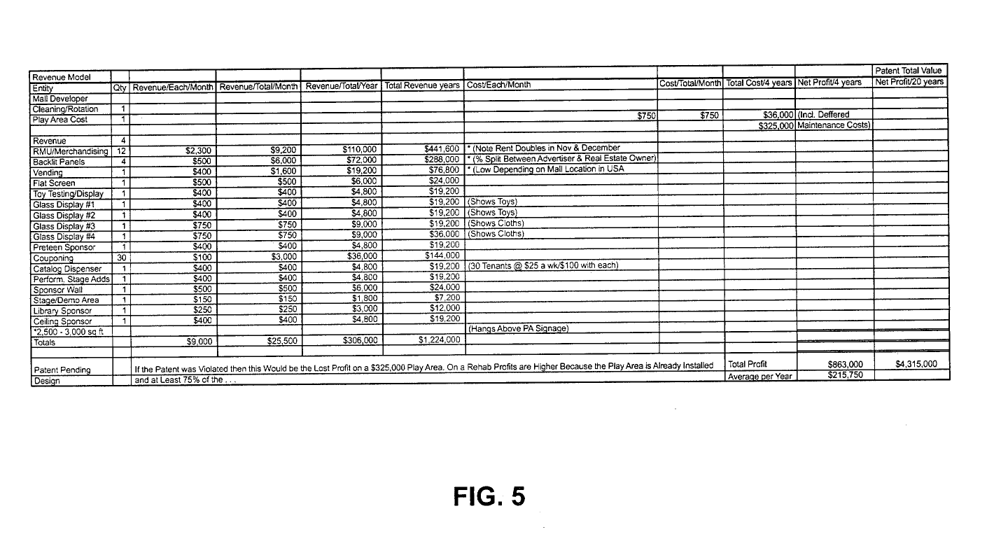

FIG. 5 illustrates a typical income stream from the various advertising opportunities. This income stream is used to offset the installation costs of the system as well as to maintain the educational programs offered at the site and online.

What is claimed is:

1. In a system configured for child recreation, a method for advertising comprising the steps of:
providing in a shopping environment a children's entertainment area;
enabling purchase of advertising space within the zones of the entertainment area, said advertising being keyed to the interests of the children within the age specific zone; and
providing a product testing area where children can play with the advertised toys.

2. A system as recited in claim 1, further comprising electronic advertising areas located on the perimeter as part of a panelized noise deflection system, viewable from both outside and inside the entertainment area, where advertisers may lease space to advertise products which tie-in to the themes in the system.

3. A system as recited in claim 1, further comprising an elevated double-sided flat video screen for showing preprogrammed video advertisements, in addition to news programs and entertainment events.

4. A system as recited in claim 1, further comprising a library.

5. A system as recited in claim 1, further comprising a stage and sound system to be used for events, product demonstrations and entertainment, and which is moveable and is attached or in the general proximity of the play area.

6. A system as recited in claim 1, wherein shoppers may purchase items that are demonstrated or displayed in the play area, and are available for purchase in stores, catalogues, or are distributed at the location or at an attached kiosk/RMU or by accessing a website on a computer.

7. A system as recited in claim 1, wherein coupons are made available to parents for the items demonstrated in the demonstration area.

8. A system as recited in claim 1, wherein coupon dispensers are made available to merchants or for stores or restaurants within the vicinity of the project or within the project for a fee.

9. A system as recited in claim 1, wherein age-specific zones are provided.

10. A system as recited in claim 1, wherein integrated vending machines sell products of the advertisers.

11. A system as recited in claim 1, wherein integrated vending machines sell snacks.

12. A system as recited in claim 1, wherein advertisers display and merchandise products in transparent enclosures in the play area for a monthly fee.

13. A system as recited in claim 1, wherein a catalog dispenser system is available to parents to purchase and learn more about the products and services of advertisers or sponsor items displayed or advertised on the site through the catalog dispenser system for a monthly fee.

14. A system as recited in claim 1, wherein each play area has an individualized website posting educational content and schedules of activities.

15. A system as recited in claim 14, wherein the website has a 12 month parent/child educational program, comprising an outbound phone, Internet and direct mail marketing program to strategic business partners of the project owner, local clubs, organizations and church groups promoting the educational program and upcoming events at the play area.

16. A system as recited in claim 1, wherein wheeled-vending carts are associated with the children's entertainment area.

17. A system as recited in claim 1, wherein kiosk-vending systems are associated with the children's entertainment area.

18. A system as recited in claim 1, wherein kiosk-vending systems are attached to the children's entertainment area.

19. A system as recited in claim 1, wherein multiple advertisers and sponsors can be accommodated.

20. A system as recited in claim 1, wherein hanging overhead thematic elements can serve as advertising space for one or more sponsors.

21. A system as recited in claim 1, wherein seasonal displays may be added as an integral part of the design and theme of the play area, in order to keep the play area new and interesting throughout the year.

22. A system as recited in claim 1, wherein museum-type displays are rotated in and out of the play area, with topics of interest to both parents and children such as “My Body,” My Feelings,” “My Family,” in order to keep the play area new and interesting throughout the year.

23. A system as recited in claim 1 added to an existing play area via a retrofit process, thus affording the existing play area the benefits of the revenue generating/advertising system and the educational system.

24. A system as recited in claim 1, wherein the complete system may be offered to an interested party through a licensing agreement in which said party would have the right to construct, operate and enjoy the revenue producing aspects of the system by paying a set fee of 33 percent of the construction costs and 15 percent of the sponsorship/advertising revenue.

25. A system configured for child recreation, comprising:
a) creating a transparent walled play area;
b) placing advertising opportunities in the play area; and
c) associating vending carts with the play area.
